(19) United States
(12) Patent Application Publication
(10) Pub. No.: US 2013/0092840 A1
(43) Pub. Date: Apr. 18, 2013

(54) RADIOLOGICAL IMAGING DEVICE

(71) Applicant: FUJIFILM Corporation, Tokyo (JP)

(72) Inventors: Yasunori OHTA, Kanagawa-ken (JP); Naoyuki NISHINO, Kanagawa-ken (JP); Haruyasu NAKATSUGAWA, Kanagawa-ken (JP); Naoto IWAKIRI, Kanagawa-ken (JP)

(73) Assignee: FUJIFILM CORPORATION, Tokyo (JP)

(21) Appl. No.: 13/680,984

(22) Filed: Nov. 19, 2012

Related U.S. Application Data
(63) Continuation of application No. PCT/JP2011/061878, filed on May 24, 2011.

(30) Foreign Application Priority Data
May 25, 2010 (JP) 2010-119555

(51) Int. Cl. G01T 1/20

(52) U.S. Cl. CPC G01T 1/2006
USPC 250/361 R

(57) ABSTRACT

Disclosed is a radiological imaging device which comprises: a radiation conversion panel which is obtained by laminating a scintillator and a photoelectric conversion layer and converts a radiation ray into a radiation image; a base which supports the radiation conversion panel mounted thereon; and a case which houses the radiation conversion panel and the base. The base supports the radiation conversion panel, while deforming the radiation conversion panel into a convex shape with respect to the mounting direction thereof.

### CROSS-REFERENCE TO RELATED APPLICATIONS AND PRIORITY CLAIM

This application is a Continuation of International Application No. PCT/JP2011/061878 filed on May 24, 2011, which was published under PCT Article 21(2) in Japanese, which is based upon and claims the benefit of priority from Japanese Patent Application No. 2010-119555 filed on May 25, 2010, the contents all of which are incorporated herein by reference.

### TECHNICAL FIELD

The present invention relates to a radiographic image capturing apparatus (radiological imaging device) having a radiation conversion panel for converting radiation into a radiographic image, the radiation conversion panel comprising a stacked assembly made up of a scintillator and a photoelectric transducer layer, a base table supporting the radiation conversion panel which is placed thereon, and a casing housing therein the radiation conversion panel and the base table.

### BACKGROUND ART

In the medical field, there have widely been used radiographic image capturing apparatus that apply radiation to a subject and guide radiation that has passed through the subject to a radiation conversion panel, which captures a radiographic image from the radiation. Known forms of radiation conversion panels include a conventional radiation film for recording a radiographic image by way of exposure, and a stimulable phosphor panel for storing radiation energy representing a radiographic image in a phosphor and reproducing the radiographic image as stimulated light by applying stimulating light to the phosphor.

Recently, there have been proposed a radiation conversion panel of a direct conversion type having a solid-state detector for converting radiation directly into an electric signal in order to read a radiographic image immediately from the radiation conversion panel after the radiographic image has been captured, and a radiation conversion panel of an indirect conversion type having a scintillator for temporarily converting radiation into scintillation light, e.g., visible light, and a solid-state detector for converting the scintillation light into an electric signal. A direct conversion or indirect conversion radiation conversion panel, and a circuit board with electronic components mounted thereon for processing a radiographic image output from the radiation conversion panel are housed in a casing, thereby making up a radiographic image capturing apparatus, i.e., a so-called electronic cassette.

For example, Japanese Laid-Open Patent Publication No. 2007-101256 discloses a radiation conversion panel in which TFTs (Thin Film Transistors) fabricated by a room-temperature process are applied to a signal output layer, which outputs a radiographic image as an electric signal (see paragraphs [0039] through [0044]). The radiation conversion panel can be reduced in weight and thickness by forming an amorphous oxide semiconductor film on a board of resin.

If an air bubble or a vacuum layer is present in a scintillator and a solid-state detector (a detector constructed as a layer may be referred to as a “photoelectric transducer layer”) in an indirect conversion type of radiation conversion panel, then the reflectance and refractive index with respect to the scintillation line vary locally, tending to bring about an irregular sensitivity distribution over a detection surface. Such an irregular sensitivity distribution is likely to reduce the quality of an acquired radiographic image. Various techniques have been disclosed in the art for enhancing intimate contact between the scintillator and the photoelectric transducer layer.

For example, Japanese Laid-Open Patent Publication No. 09-054162 reveals an apparatus in which a scintillator and a photoelectric transducer layer are spaced a given distance from each other by a spacer and are bonded to each other by an adhesive (see paragraphs [0021] through [0023], FIG. 2).

Japanese Laid-Open Patent Publication No. 09-257944 discloses an apparatus in which a closed space is defined by a solid-state detecting means, a sealing means, and a cover means, and the closed space is evacuated by an evacuating means (see paragraph [0042], FIG. 1).

### SUMMARY OF INVENTION

According to the apparatus disclosed in Japanese Laid-Open Patent Publication No. 09-054162 and Japanese Laid-Open Patent Publication No. 09-257944, the number of parts of the radiation conversion panel is increased. Further, a separate fabrication process is needed, resulting in an increase in fabrication costs.

It is generally known in the art that a resin material has a higher coefficient of thermal expansion than glass and is more likely to expand thermally. If heat is stored in an assembly of bonded materials having different coefficients of thermal expansion, then the materials tend to peel off and crack due to thermal stresses produced at interfaces between the bonded materials, thereby impairing intimate contact between such materials.

Electronic cassettes that handle high-resolution radiographic images have a number of pixels that need to be electrically processed. Therefore, the circuit boards of such electronic cassettes are likely to give off a large amount of heat. As disclosed in Japanese Laid-Open Patent Publication No. 2007-101256, if a resin material having a high coefficient of thermal expansion is used as a circuit board material, then a problem of impaired intimate contact between the circuit board and the base table on which the radiation conversion panel is mounted arises, similar to the case of the aforementioned scintillator and solid-state detector.

The present invention has been made in view of the above problems. It is an object of the present invention to provide a radiographic image capturing apparatus, which increases intimate contact between a scintillator and a photoelectric transducer layer by means of a simple structure, and which prevents intimate contact between a radiation conversion panel and a base table from becoming lowered due to thermal deformation.

According to the present invention, there is provided a radiographic image capturing apparatus comprising a radiation conversion panel for converting radiation into a radiographic image, the radiation conversion panel comprising a stacked assembly made up of a scintillator and a photoelectric transducer layer, a base table supporting the radiation conversion panel which is placed on the base table, and a casing housing the radiation conversion panel and the base table in the casing.

The base table supports the radiation conversion panel while deforming the radiation conversion panel into a convex shape along a direction in which the radiation conversion panel is placed on the base table.

As described above, the radiographic image capturing apparatus includes the base table, which supports the radiation conversion panel while deforming the radiation conversion panel into a convex shape along a direction in which the radiation conversion panel is placed on the base table. Therefore, tensile forces are generated at marginal edges along directions in which the radiation conversion panel extends under the weight of the radiation conversion panel, which is deformed in a convex shape. Accordingly, stresses are developed on the face and reverse sides of the radiation conversion panel. Therefore, the scintillator and the photoelectric transducer layer of the radiation conversion panel are held very closely together, i.e., are held in highly intimate contact with each other, by means of a simple structure.

Even though the radiation conversion panel is deformed (warped) along pre-deformed directions, bending stresses, which are developed within the radiation conversion panel, are not detrimental. In other words, intimate contact between the radiation conversion panel and the base table is prevented from becoming reduced due to thermal deformation.

The base table preferably supports the radiation conversion panel while curving the radiation conversion panel. Therefore, the detected dose of radiation has a continuous, i.e., smooth, two-dimensional profile, thereby preventing sharp stripe irregularities from being generated in the radiographic image.

The base table preferably supports the radiation conversion panel while deforming the radiation conversion panel axisymmetrically with respect to a prescribed axis on a detecting surface of the radiation conversion panel.

The prescribed axis preferably comprises a central line of the detecting surface.

The radiation conversion panel preferably has at least a pair of side surfaces fixed to inner wall surfaces of the casing. With this arrangement, since the radiation conversion panel is deformed in a direction of placement thereof, a vertical component of stress imposed on the radiation conversion panel increases, thereby enhancing intimate contact between the scintillator and the photoelectric transducer layer.

The base table preferably is made of a resin material in order to make the radiographic image capturing apparatus smaller in weight and thickness.

The base table preferably is made of an electromagnetic wave shielding material. A base table constructed in this manner exhibits an electromagnetic wave shielding capability for preventing electronic components in the radiation conversion panel and external electronic devices from malfunctioning.

The radiographic image capturing apparatus preferably further comprises an image corrector for correcting the radiographic image depending on an extent of deformation of the radiation conversion panel. The image corrector is capable of correcting the dose of radiation that enters the detecting surface of the radiation conversion panel for thereby increasing in-plane uniformity of the radiographic image.

The image corrector preferably estimates an extent of deformation of the radiation conversion panel based on the shape of the base table and corrects the radiographic image. The radiographic image can thus be corrected highly accurately from the shape of the base table, without the need for measuring the extent of deformation of the radiation conversion panel.

The radiographic image capturing apparatus according to the present invention includes the base table, which supports the radiation conversion panel while deforming the radiation conversion panel into a convex shape along the direction in which the radiation conversion panel is placed on the base table. Since tensile forces are generated at marginal edges along the direction in which the radiation conversion panel extends under the weight of the radiation conversion panel, which is deformed in a convex shape, stresses are developed on the face and reverse sides of the radiation conversion panel. Therefore, the scintillator and the photoelectric transducer layer of the radiation conversion panel are held very closely together, i.e., are held in highly intimate contact with each other, by means of a simple structure.

Even though the radiation conversion panel is deformed (warped) along pre-deformed directions, bending stresses developed within the radiation conversion panel are not detrimental. In other words, intimate contact between the radiation conversion panel and the base table is prevented from becoming reduced due to thermal deformation.

### BRIEF DESCRIPTION OF DRAWINGS

FIG. 1 is a schematic view of a radiographic image capturing system incorporating an electronic cassette according to a first embodiment of the present invention;

FIG. 2 is a perspective view of the electronic cassette shown in FIG. 1;

FIG. 3 is a block diagram showing a matrix of pixels of a radiation conversion panel, and electrical connections between the pixels and a cassette controller;

FIG. 4 is a block diagram showing a circuit arrangement of the electronic cassette shown in FIG. 1;

FIG. 5 is a cross-sectional view of the electronic cassette shown in FIG. 1 taken along line V-V of FIG. 2;

FIG. 6 is a cross-sectional view of the electronic cassette shown in FIG. 1 taken along line VI-VI of FIG. 2;

FIGS. 7A through 7C are views showing the manner in which the radiation conversion panel shown in FIGS. 5 and 6 is placed on a base table;

FIGS. 8A through 8C are views showing the shape of a base table in an electronic cassette according to a first modification;

FIGS. 9A through 9C are views showing the shape of a base table in an electronic cassette according to a second modification;

FIGS. 10A through 10C are views showing the shape of a base table in an electronic cassette according to a third modification;

FIG. 11 is an enlarged fragmentary cross-sectional view of an electronic cassette according to a fourth modification taken along line XI-XI of FIG. 2;

FIG. 12 is a schematic view of a radiographic image capturing system incorporating an electronic cassette according to a second embodiment of the present invention;

FIG. 13 is a perspective view of the electronic cassette shown in FIG. 12;

FIG. 14 is a cross-sectional view of the electronic cassette shown in FIG. 13 taken along line XIV-XIV of FIG. 13;

FIG. 15 is an exploded perspective view of a base table shown in FIG. 14;

FIGS. 16A and 16B are views showing the shape of a base table in an electronic cassette according to a first modification;

FIG. 17 is an enlarged fragmentary cross-sectional view of an electronic cassette according to a second modification taken along line XVII-XVII of FIG. 13;

FIG. 18A is a view schematically showing an internal arrangement of an electronic cassette; and

FIG. 18B is a view schematically showing an example of a scintillator shown in FIG. 18A.

### DESCRIPTION OF EMBODIMENTS

Radiographic image capturing apparatus according to preferred embodiments of the present invention will be described in detail below with reference to the accompanying drawings.

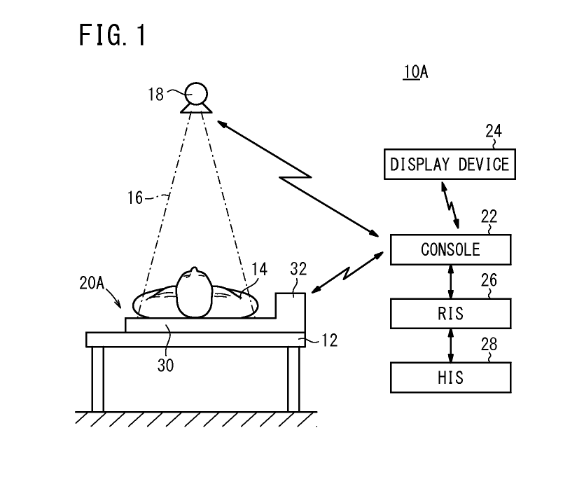

A radiographic image capturing system 10A according to a first embodiment of the present invention will be described below with reference to FIGS. 1 through 7.

As shown in FIG. 1, the radiographic image capturing system 10A has a radiation source 18 for applying radiation 16 of a dose according to image capturing conditions to a subject 14 as a patient lying on an image capturing base 12 such as a bed or the like, an electronic cassette (radiographic image capturing apparatus) 20A for detecting radiation 16 that has passed through the subject 14 and converting the detected radiation 16 into a radiographic image, a console 22 for controlling the radiation source 18 and the electronic cassette 20A, and a display device 24 for displaying radiographic images.

The console 22, the radiation source 18, the electronic cassette 20A, and the display device 24 send signals to and receive signals from each other via a wireless communication link such as an UWB (Ultra Wide Band) communication link, a wireless LAN (Local Area Network) according to standards such as IEEE 802.11.a/g/n, or a millimeter-wave communication link. Alternatively, signals may be sent and received between such components via wired communications using cables.

The console 22 is connected to a radiology information system (RIS) 26, which generally manages radiographic images and other information that are handled in the radiological department of a hospital. The RIS 26 is connected to a hospital information system (HIS) 28, which generally manages medical information in the hospital.

The electronic cassette 20A is a portable electronic cassette including a panel housing unit 30 disposed between the image capturing base 12 and the subject 14. The panel housing unit 30 includes an upwardly projecting right-hand side portion, which functions as a control unit 32.

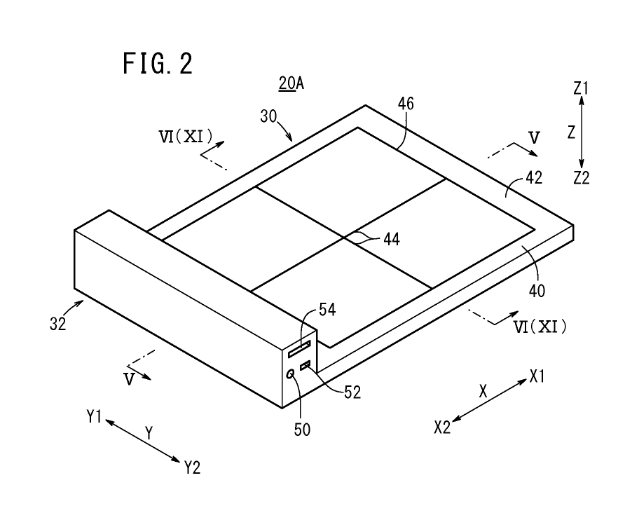

As shown in FIG. 2, the panel housing unit 30 has a substantially rectangular casing 40 made of a material permeable to radiation 16. The casing 40 has an upper surface on which the subject 14 lies, and which serves as an image capturing surface (irradiated surface) 42 that is irradiated with radiation 16. The casing 40 has guide lines 44 disposed centrally on the image capturing surface 42 and serving as a reference for an image capturing position for the subject 14. The guide lines 44 provide an outer frame, which defines an image capturing field 46 indicative of an area that can be irradiated with radiation 16. The guide lines 44 include two crisscross guide lines crossing each other at a central position, which serves as the central position of the image capturing field 46.

The control unit 32 has, on a side surface thereof facing in the direction indicated by the arrow Y2, an AC adapter input terminal 50 for charging the electronic cassette 20A from an external power supply, a USB (Universal Serial Bus) terminal 52 that serves as an interface means for sending information to and receiving information from an external device, and a card slot 54 for receiving a memory card such as a PC card or the like inserted therein.

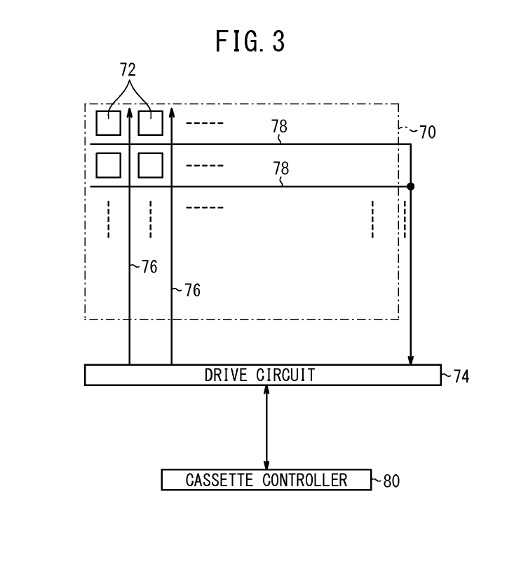

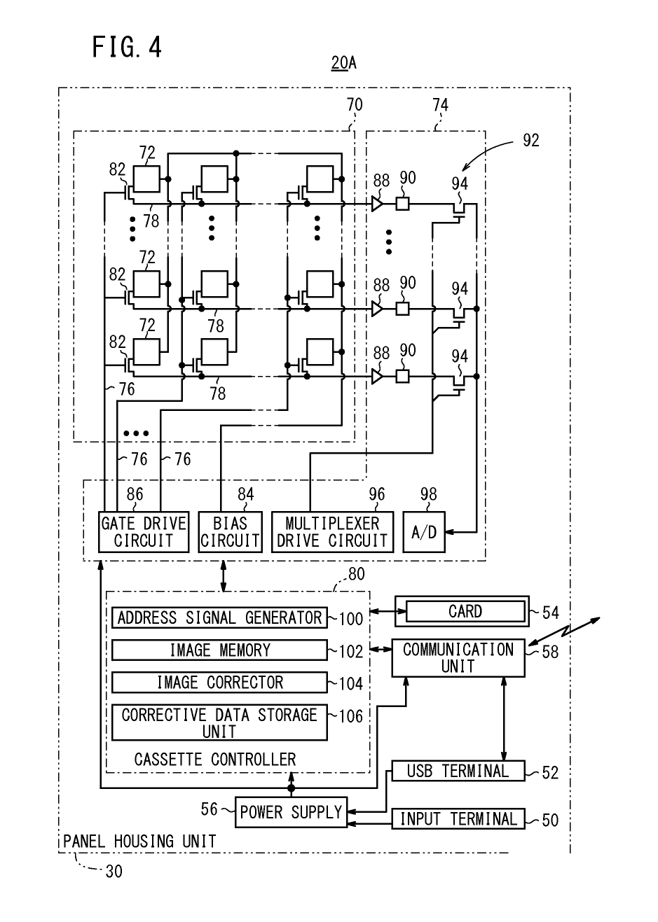

The casing 40 houses therein a radiation conversion panel 70 and a drive circuit 74 (see FIGS. 3 and 4). The radiation conversion panel 70 comprises an indirect conversion type of radiation conversion panel including a scintillator for converting radiation 16 having passed through the subject 14 into scintillation light in a visible light range, and photoelectric transducers made of amorphous silicon (a-Si) or the like for converting the scintillation light into an electric signal. The wavelength of the scintillation light mainly resides within the visible light range, but may include an ultraviolet range or an infrared range.

The casing 40 also houses, in the control unit 32, components that are not involved in the conversion of radiation 16 into radiographic images, e.g., a power supply 56 such as a battery or the like, and a communication unit 58 for sending signals to and receiving signals from the console 22 through a wireless communication link (see FIG. 4).

FIG. 3 is a block diagram showing a matrix of pixels 72 of the radiation conversion panel 70, and electrical connections that are provided between the pixels 72 and a cassette controller 80. The pixels 72 are arrayed on a substrate, not shown. The pixels 72 are supplied with control signals from the drive circuit 74 through a plurality of gate lines 76. The pixels 72 output electric signals to the drive circuit 74 through a plurality of signal lines 78. Each of the pixels 72 comprises a photoelectric transducer. The cassette controller 80, which is housed in the control unit 32, supplies control signals to the drive circuit 74 in order to control the drive circuit 74.

FIG. 4 is a block diagram showing a circuit arrangement of the electronic cassette 20A. The radiation conversion panel 70 comprises an array of TFTs 82 arranged in rows and columns, and a photoelectric conversion layer including the pixels 72. Each of the pixels 72 comprises a photoelectric transducer made of a material such as a-Si for converting scintillation light into an electric signal. The photoelectric conversion layer is disposed on the array of TFTs 82. The pixels 72, which are supplied with a bias voltage from a bias circuit 84 of the drive circuit 74, generate electric charges by converting scintillation light into analog electric signals, and then store the generated electric charges. When the TFTs 82 are turned on along each row at a time, the stored electric charges are read from the pixels 72 as an image signal.

The TFTs 82 are connected to respective pixels 72. Gate lines 76, which extend parallel to the columns, and signal lines 78, which extend parallel to the rows, are connected to the TFTs 82. The gate lines 76 are connected to a gate drive circuit 86, and the signal lines 78 are connected to a multiplexer 92 of the drive circuit 74. The gate lines 76 are supplied with control signals from the gate drive circuit 86 for turning on and off the TFTs 82 along the columns. The gate drive circuit 86 is supplied with address signals from the cassette controller 80, and turns the TFTs 82 on and off based on the address signals.

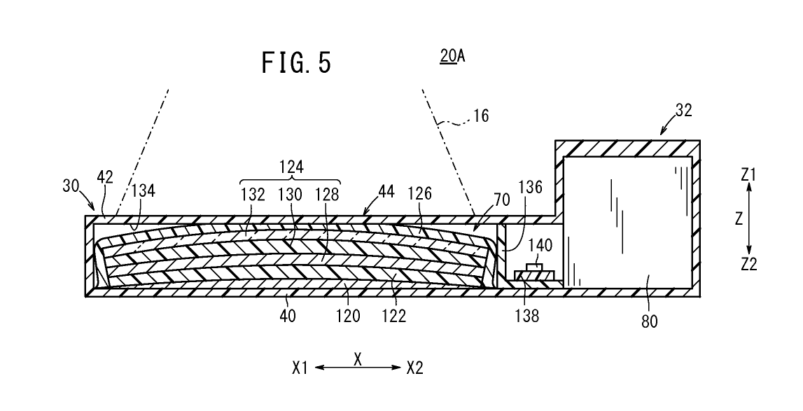

The signal lines 78 are supplied with electric charges stored in the pixels 72 through the TFTs 82 arranged in the rows. The electric charges supplied to the signal lines 78 are amplified by amplifiers 88 connected respectively to the signal lines 78. The amplifiers 88 are connected through respective sample and hold circuits 90 to the multiplexer 92. The multiplexer 92 includes a plurality of FET (Field Effect Transistor) switches 94 for successively switching between the signal lines 78, and a multiplexer drive circuit 96 for outputting selection signals for turning on one of the FET switches 94 at a time. The multiplexer drive circuit 96 is supplied with address signals from the cassette controller 80, and turns on one of the FET switches 94 at a time based on the address signals. The FET switches 94 are connected to an A/D converter 98. The A/D converter 98 converts the analog electric signals from the pixels 72 into digital signals representative of a radiographic image. The digital signals are supplied through a flexible board 138 (see FIG. 5) to the cassette controller 80. The flexible board 138 electrically connects the cassette controller 80 and the drive circuit 74 to each other.

The TFTs 82, which function as switching elements, may be combined with any of various other image capturing devices, such as a CMOS (Complementary Metal-Oxide Semiconductor) image sensor or a CCD (Charge-Coupled Device) image sensor in which electric charges are shifted and transferred by shift pulses corresponding to gate signals used by the TFTs 82.

The cassette controller 80 includes an address signal generator 100 for generating address signals to be supplied to the gate drive circuit 86 and the multiplexer drive circuit 96, an image memory 102 for storing radiographic images, an image corrector 104 for correcting radiographic images detected by the radiation conversion panel 70, and a corrective data storage unit 106 for storing corrective data depending on an extent of deformation of the radiation conversion panel 70. Radiographic images stored in the image memory 102 are sent to the console 22 from the communication unit 58.

The power supply 56 supplies electric power to the drive circuit 74 as well as to the cassette controller 80 and the communication unit 58.

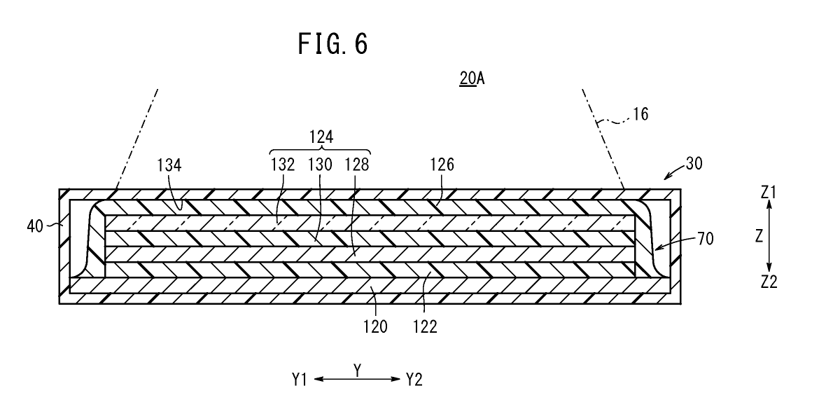

Internal structural details of the electronic cassette 20A will be described below with reference to FIGS. 5 and 6. For illustrative purposes, the structure of the radiation conversion panel 70 is schematically shown in FIGS. 5 and 6, and some of the components housed in the casing 40 are shown as exaggerated in terms of size or the like.

FIG. 5 is a cross-sectional view of the electronic cassette 20A taken along line V-V of FIG. 2, which extends parallel to the direction indicated by the arrow X. FIG. 6 is a cross-sectional view of the electronic cassette 20A taken along line VI-VI of FIG. 2, which extends parallel to the direction indicated by the arrow Y.

As shown in FIG. 5, the radiation conversion panel 70 includes a board 122 placed on a base table 120, a radiation conversion layer 124 mounted on the board 122 for converting radiation 16 into an electric signal representative of a radiographic image, and a protective film 126 covering side and upper surfaces of the radiation conversion layer 124 on the board 122, so as to protect the radiation conversion layer 124 from humidity, etc.

As shown in FIGS. 5 and 6, the base table 120 is of a shape that bulges in the direction indicated by the arrow Z1 and has, on an apex thereof, the guide line 44 (see FIG. 2) that extends along the direction indicated by the arrow Y. The base table 120 may be made of any of various materials such as glass, resin, metal including Mg (magnesium), or carbon.

The board 122 comprises a substantially rectangular flexible board made of plastic in order to reduce the overall weight of the electronic cassette 20A.

The radiation conversion layer 124, which has substantially the same area as the image capturing field 46 as viewed in plan, includes a signal output layer 128 disposed on the board 122, a photoelectric transducer layer 130 deposited on the signal output layer 128, and a scintillator 132 bonded to or held closely, i.e., in intimate contact, with the photoelectric transducer layer 130. The scintillator 132, which is made of columnar crystals of CsI (cesium iodide) or the like disposed perpendicular to the board 122, converts radiation 16 into scintillation light.

An adhesive, for example, may be used to bond the photoelectric transducer layer 130 and the scintillator 132 to each other in order to prevent dust from entering between the photoelectric transducer layer 130 and the scintillator 132, as well as to prevent the photoelectric transducer layer 130 and the scintillator 132 from becoming positionally displaced. The photoelectric transducer layer 130 and the scintillator 132, which are bonded to each other, are held very closely, i.e., are held in highly intimate contact with each other. According to the present embodiment, however, intimate contact between the photoelectric transducer layer 130 and the scintillator 132 can be achieved without the need for an adhesive.

The photoelectric transducer layer 130, which includes the pixels 72 made of an amorphous oxide semiconductor, e.g., IGZO, or OPC (organic photoconductor), converts scintillation light into electric signals. The signal output layer 128 comprises an array of TFTs on the board 122 fabricated from an amorphous oxide semiconductor, e.g., IGZO, according to a room-temperature process. The signal output layer 128 reads electric signals from the photoelectric transducer layer 130 and outputs the read electric signals.

Normally, if the radiation conversion panel 70 is in a free state, the radiation conversion panel 70 has a substantially uniform thickness within a plane thereof. When housed in the casing 40, the radiation conversion panel 70 is deformed into a convex shape along the direction in which the radiation conversion panel 70 is placed, i.e., the direction (hereinafter also referred to as a “placed direction”) indicated by the arrow Z1 (see FIG. 5). Therefore, the surface of the protective film 126 is held in contact with a portion of an inner wall surface 134 of the upper wall of the casing 40.

As described above, the board 122 is made of a flexible plastic having a coefficient of thermal expansion on the order of 10⁻⁵/° C. If the board 122 is made of metal, the coefficient of thermal expansion of which is on the order of 10⁻⁶/° C., then the following problems arise. Namely, if heat is stored in an assembly made up of bonded materials having different coefficients of thermal expansion, then the materials tend to peel off and crack due to thermal stresses produced at the interface. According to the present embodiment, the base table 120 and the board 122 are not bonded to each other, but rather, the board 122 (radiation conversion panel 70) is placed on the base table 120.

If the base table 120 and the board 122 are made of the same material, then the radiation conversion panel 70 (board 122) may be bonded to the base table 120. Further, if the base table 120 and the board 122 are made of different materials, but the coefficients of thermal expansion thereof are substantially the same, then the radiation conversion panel 70 (board 122) may be bonded to the base table 120. In such cases, it is preferable for the radiation conversion panel 70 to be bonded to the base table 120 using an adhesive made of a material having a coefficient of thermal expansion that is substantially the same as the coefficients of thermal expansion of the materials used for the base table 120 and the board 122.

As shown in FIG. 5, a fixture 136 having an L-shape in cross section is disposed on one side of the base table 120, which faces in the direction indicated by the arrow X2. The fixture 136 also extends in the directions indicated by the arrow Y. The fixture 136 fixes the base table 120 and the radiation conversion panel 70 in position. More specifically, the fixture 136 positions the radiation conversion panel 70 so as to keep the radiation conversion layer 124 and the image capturing field 46 in a superimposed relation to each other.

A flexible board 138 is secured to an upper surface of the fixture 136. A plurality of electronic parts 140 are mounted on the flexible board 138. The flexible board 138 is connected to the cassette controller 80.

The cassette controller 80 sends signals to and receives signals from the drive circuit 74 and the radiation conversion layer 124 through the flexible board 138. The power supply 56 supplies electric power to the cassette controller 80, the communication unit 58, etc., in the casing 40, and also supplies electric power to the drive circuit 74 and the radiation conversion layer 124 through the flexible board 138.

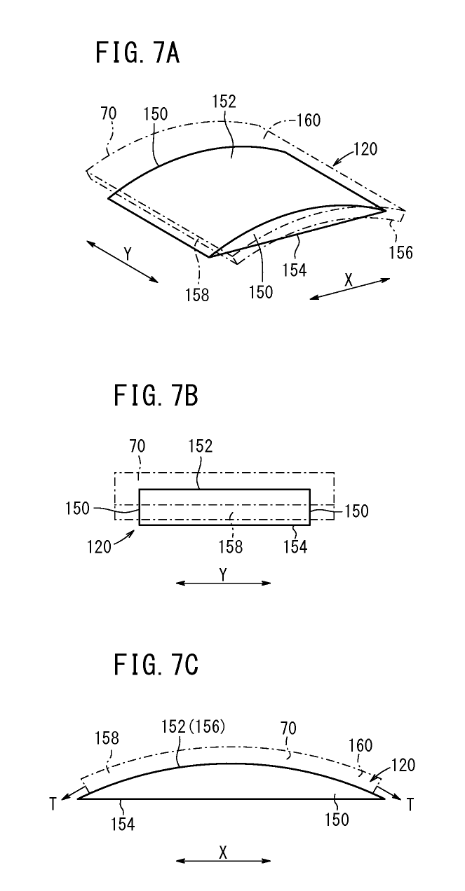

FIGS. 7A through 7C are views showing the manner in which the radiation conversion panel 70 is placed on the base table 120. In FIGS. 7A through 7C, other components apart from the radiation conversion panel 70 and the base table 120 are omitted from illustration. Although the curvature of the base table 120 is shown as greater than the curvature shown in FIG. 5, the curvature is shown in exaggerated form merely to facilitate understanding of the present invention, and the actual size thereof is not represented in the drawing.

The base table 120 has upwardly convex arcuate side surfaces 150 facing in the directions indicated by the arrow Y, and the base table 120 also extends in the direction of the arrow Y. The base table 120 also has an upper surface 152, which is formed as a smooth curved surface, and a bottom surface 154 lying parallel to the image capturing surface 42 that is irradiated with radiation 16.

The radiation conversion panel 70 is supported on the base table 120, with a reverse surface 156 thereof being held in contact with the upper surface 152. At this time, one end portion 158 and another end portion 160 of the radiation conversion panel 70 are curved along the curved shape of the upper surface 152 under tensile forces T (see FIG. 7C) acting on the radiation conversion panel 70 due to the weight of the radiation conversion panel 70.

Since the base table 120 supports the radiation conversion panel 70 while deforming the radiation conversion panel 70 convexly in the direction indicated by the arrow Z1 (placed direction), tensile forces T are generated along directions in which the radiation conversion panel 70 extends under the weight of the radiation conversion panel 70 at marginal edges (the end portion 158 and the other end portion 160) thereof. Accordingly, stresses are developed on the face and on the reverse side of the radiation conversion panel 70. Therefore, the scintillator 132 and the photoelectric transducer layer 130 of the radiation conversion panel 70 are held very closely together, i.e., are held in highly intimate contact with each other, by means of a simple structure.

Even though the radiation conversion panel 70 is deformed (warped) along pre-deformed directions, bending stresses developed within the radiation conversion panel 70 are not detrimental. In other words, intimate contact between the radiation conversion panel 70 and the base table 120 is prevented from becoming reduced due to thermal deformation.

Inasmuch as the base table 120 supports the radiation conversion panel 70 in a curved shape, the detected dose of radiation 16 has a continuous (i.e., smooth) two-dimensional profile, thereby preventing sharp stripe irregularities from occurring in the generated radiographic images.

If a radiographic image is captured according to a normal process while the above positional relationship between the radiation conversion panel 70 and the base table 120 is maintained, then the radiographic image may become distorted owing to the deformation of the radiation conversion panel 70. The image corrector 104 (see FIG. 4) of the cassette controller 80 suitably corrects the radiographic image based on the corrective data that are acquired from the corrective data storage unit 106.

More specifically, the image corrector 104 converts and corrects a distorted radiographic image into a planar projected image, e.g., a planar projected image that would be generated if the base table 120 were a flat plate, based on the electric signals acquired from the pixels 72 and the positions of the pixels 72. Any of various known algorithms may be used to convert a distorted radiographic image into a planar projected image.

If it is difficult to measure the actual shape of the radiation conversion panel 70, then the shape of the radiation conversion panel 70 may be estimated. Alternatively, a corrective quantity for the radiographic image may be estimated directly based on various parameters of the base table 120, including the shape thereof.

The corrective data storage unit 106 stores corrective data determined based on the shape of the base table 120. If the radiation conversion panel 70 has a curved surface, then the corrective data may comprise curvature data. The corrective data may also comprise geometrical data representing a distance, i.e., a measured distance value or a typical distance value, by which the radiation conversion panel 70 is spaced from the radiation source 18, as well as the positional relationship between the image capturing surface 42 and the base table 120.

The shape of the radiation conversion panel 70 preferably is axisymmetrical with respect to a given axis (single axis) on the detecting surface, or more specifically, the image capturing surface 42 or the image capturing field 46 of the detecting surface. The given axis preferably is either one of the two guide lines 44 that extend along the directions indicated by the arrows X and Y. The axisymmetrical shape of the radiation conversion panel 70 makes the extent of deformation of the radiation conversion panel 70, or the corrective quantity for the radiographic image, vertically or horizontally symmetrical, thereby reducing the amount of computation required for the image correcting process.

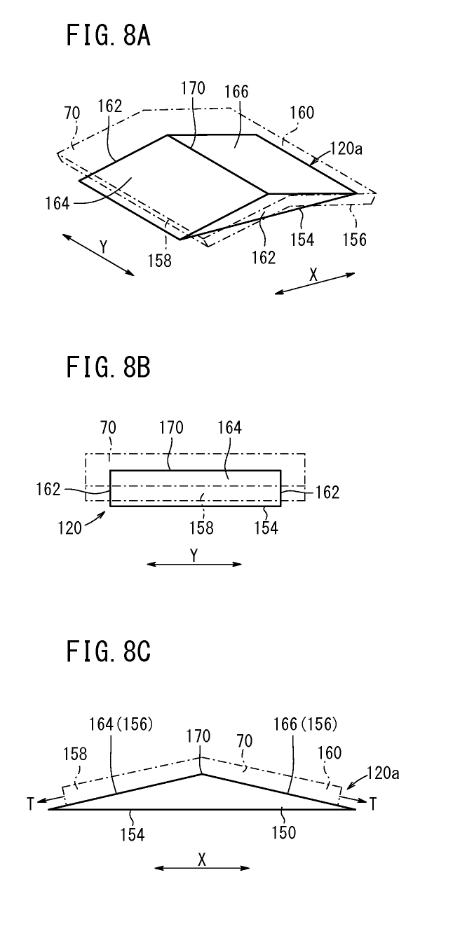

First through fourth modifications of the electronic cassette 20A according to the first embodiment will be described below with reference to FIGS. 8A through 11.

The first through third modifications differ from the first embodiment as to the shape of the base tables 120a through 120c. The first through third modifications will be described below with reference to FIGS. 8A through 10C, which show the manner in which the radiation conversion panel 70 is placed on the base table 120, similar to FIGS. 7A through 7C.

A first modification of the first embodiment will be described below with reference to FIGS. 8A through 8C.

The base table 120a has side surfaces 162, each in the shape of an isosceles triangle, facing in directions indicated by the arrow Y, and the base table 120a also extends in the directions of the arrow Y. The base table 120a has a first slanted surface 164 and a second slanted surface 166, which have the same area and the same angle of inclination. The first slanted surface 164 and the second slanted surface 166 intersect each other at a ridge 170.

The radiation conversion panel 70 is supported on the base table 120a, with the reverse surface 156 thereof being held in contact with the first slanted surface 164 and the second slanted surface 166. At this time, the end portion 158 of the radiation conversion panel 70 is curved or bent along the first slanted surface 164, and the other end portion 160 is curved or bent along the second slanted surface 166 under tensile forces T (see FIG. 8C) that act on the radiation conversion panel 70 due to the weight of the radiation conversion panel 70. The radiation conversion panel 70 is deformed depending on the rigidity thereof in the vicinity of the ridge 170.

Even though the base table 120a has a differently shaped surface that is held in contact with the reverse surface 156 of the radiation conversion panel 70, the base table 120a operates in the same manner and offers the same advantages as the base table 120 according to the first embodiment (see FIGS. 7A through 7C).

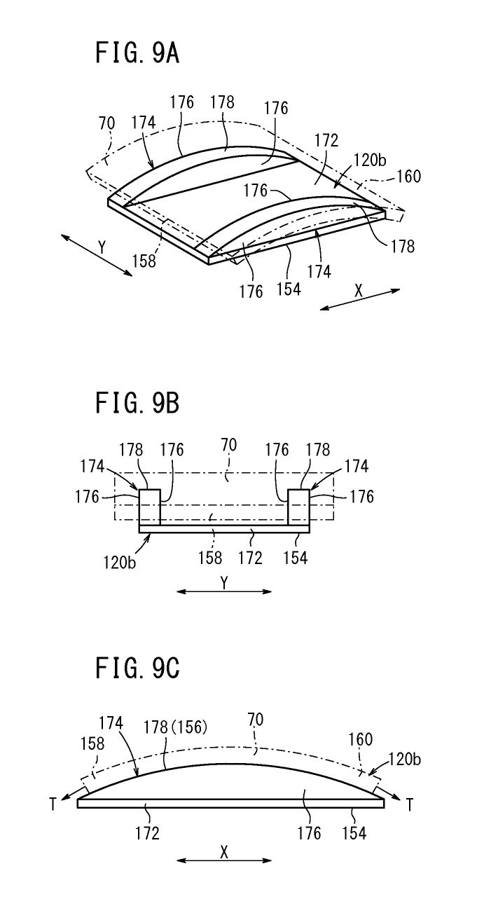

A second modification of the first embodiment will be described below with reference to FIGS. 9A through 9C.

The base table 120b comprises a plate-like flat portion 172 and two ledges 174 disposed on respective marginal edges on both sides of the flat portion 172, which face in directions indicated by the arrow Y. The two ledges 174 are identical in shape and extend in parallel with each other. The two ledges 174 are erected along a direction normal to the plane of the flat portion 172 and have respective arcuate side surfaces 176. The two ledges 174 have respective upper surfaces 178, each of which is in the form of a smooth curved surface.

The radiation conversion panel 70 is supported on the base table 120b, with the reverse surface 156 thereof being held in contact with the two upper surfaces 178. At this time, the end portion 158 and the other end portion 160 of the radiation conversion panel 70 are curved along the curved shapes of the upper surfaces 178 under tensile forces T (see FIG. 9C) acting on the radiation conversion panel 70 due to the weight of the radiation conversion panel 70.

Although the base table 120b supports the radiation conversion panel 70 with the reverse surface 156 held partially, but not completely, in contact with the upper surfaces 178, the base table 120b operates in the same way and offers the same advantages as the base table 120 according to the first embodiment (see FIGS. 7A through 7C).

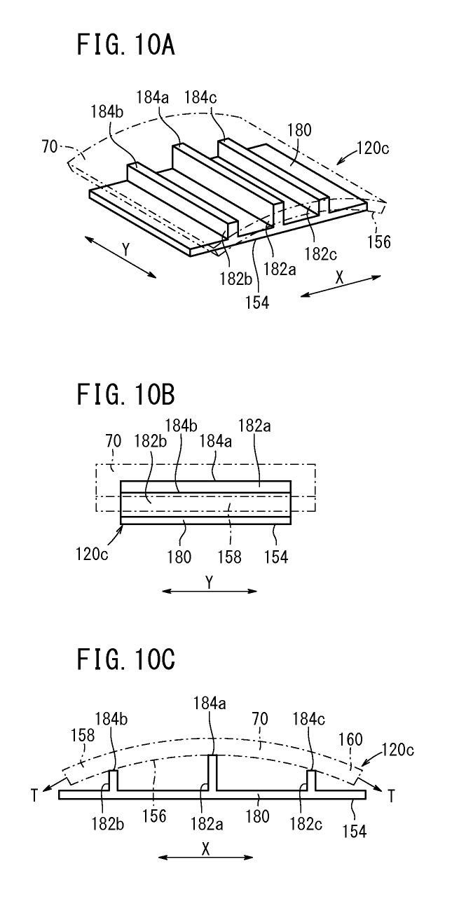

The third modification of the first embodiment will be described below with reference to FIGS. 10A through 10C.

The base table 120c comprises a plate-like flat portion 180, a first ledge 182a disposed centrally on the flat portion 180 along the direction indicated by the arrow X, a second ledge 182b disposed on the flat portion 180 close to the marginal edge of one side thereof along the direction indicated by the arrow X, and a third ledge 182c disposed on the flat portion 180 close to the marginal edge of an opposite side thereof along the direction indicated by the arrow X. The first, second, and third ledges 182a, 182b, 182c are each in the form of a rectangular plate extending in directions indicated by the arrow Y, and which extend in parallel with each other. The first, second, and third ledges 182a, 182b, 182c are erected along a direction normal to the plane of the flat portion 180. The second ledge 182b and the third ledge 182c have the same height as each other, whereas the first ledge 182a is of a height greater than the second ledge 182b and the third ledge 182c. The first, second, and third ledges 182a, 182b, 182c have end surfaces each of which has a vertically elongate rectangular shape. The first, second, and third ledges 182a, 182b, 182c have respective first, second, and third surfaces 184a, 184b, 184c formed as flat surfaces lying substantially parallel to the flat portion 180.

The radiation conversion panel 70 is supported on the base table 120c, with the reverse surface 156 thereof being held in contact with the first, second, and third surfaces 184a, 184b, 184c. At this time, the end portion 158 and the other end portion 160 of the radiation conversion panel 70 are curved along an envelope defined by the steps provided on the first, second, and third ledges 182a, 182b, 182c, under tensile forces T (see FIG. 10C) that act on the radiation conversion panel 70 due to the weight thereof.

Although rather than curving the radiation conversion panel 70 along a given curved surface, the base table 120c keeps the radiation conversion panel 70 curved by supporting the reverse surface 156 at points of different heights arrayed in a certain direction, and the base table 120c operates in the same way and offers the same advantages as the base table 120 according to the first embodiment (see FIGS. 7A through 7C).

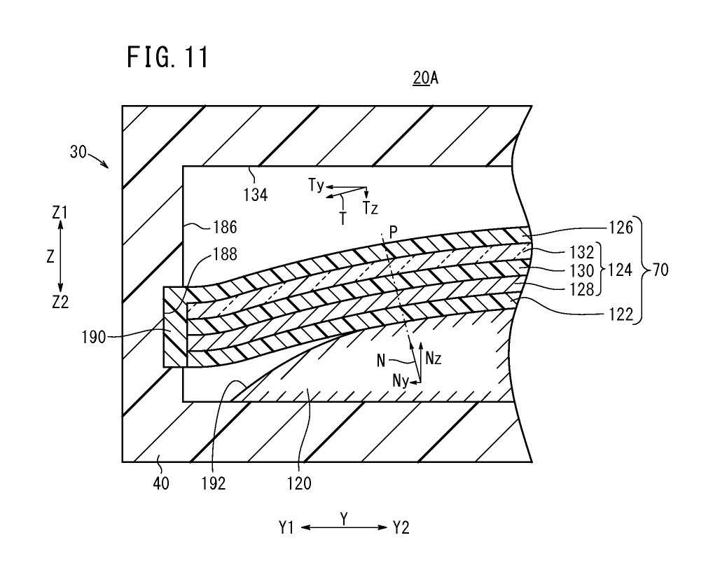

A fourth modification of the first embodiment will be described below with reference to FIG. 11. FIG. 11 is an enlarged fragmentary cross-sectional view of the electronic cassette 20A shown in FIG. 5, taken along line XI-XI of FIG. 2.

The fourth modification differs from the first embodiment in that the radiation conversion panel 70 is supported not only by the base table 120, but also by the casing 40.

The casing 40 includes a side wall 186 that faces in the direction indicated by the arrow Y1. The side wall 186 has a recess 188 defined in an inner wall surface thereof. The radiation conversion panel 70 has an end 190 engageable in the recess 188. Similarly, the casing 40 includes an opposite side wall that faces in the direction indicated by the arrow Y2. Further, the side wall has a recess, not shown, defined in an inner wall surface thereof at the same height as the recess 188 along the direction indicated by the arrow Z.

A process of housing the radiation conversion panel 70 and the base table 120 in the casing 40 will be described below.

First, the radiation conversion panel 70 is fixed to the side wall 186 of the casing 40 by an adhesive or the like with the end 190 engaging in the recess 188. Similarly, the radiation conversion panel 70 also is fixed to the other side wall of the casing 40. The radiation conversion panel 70, which is fixed in this manner, is spaced a prescribed distance from an inner wall surface of the bottom wall of the casing 40.

Then, the base table 120 is forcibly inserted between the radiation conversion panel 70 and the inner wall surface of the bottom wall of the casing 40, thereby pushing the radiation conversion panel 70 upwardly along the direction of the arrow Z1.

At this time, the radiation conversion panel 70 undergoes a resistive force N from the base table 120 at a position P. The resistive force N is generated in a direction normal to an outer peripheral surface 192 of the base table 120. The radiation conversion panel 70 also is displaced depending on the shape of the base table 120, which is positioned underneath the radiation conversion panel 70. Since the end 190 of the radiation conversion panel 70 is fixed to the casing 40, the radiation conversion panel 70 is subjected to a tensile force T along the direction in which the radiation conversion panel 70 extends.

More specifically, at the position P, the radiation conversion panel 70 undergoes a Z component Nz of the resistive force N in the direction indicated by the arrow Z1, and also undergoes a Z component Tz of the tensile force T in the direction indicated by the arrow Z2. Since the signal output layer 128 and the protective film 126 are pressed by such force components, the photoelectric transducer layer 130 and the scintillator 132, which are disposed inwardly of the signal output layer 128 and the protective film 126, also are pressed. Therefore, the photoelectric transducer layer 130 and the scintillator 132 are held in highly intimate contact with each other.

In addition, marginal edges of the radiation conversion panel 70, i.e., peripheral regions around the point P, and the base table 120 also are held in highly intimate contact with each other.

The radiation conversion panel 70 may have at least a pair of side edges or ends, which are fixed to corresponding inner wall surfaces of the casing 40. The above advantages can thus be achieved by fixing all of the four side edges or ends of the radiation conversion panel 70 to the corresponding inner wall surfaces of the casing 40.

Another advantage, to be described below, is accomplished by fixing side edges or ends of the radiation conversion panel 70 to corresponding inner wall surfaces of the casing 40. Namely, if one of the scintillator 132 and the board 122, which is lighter than the other, is positioned above the other in the direction indicated by the arrow Z1, then intimate contact, which is achieved between the stacked layers under the weight of the radiation conversion panel 70, is considered to be reduced. However, since the side edges or ends of the radiation conversion panel 70 are fixed to corresponding inner wall surfaces of the casing 40, the radiation conversion panel 70 is pressed more strongly by the base table 120 than if the side edges or ends of the radiation conversion panel 70 were not fixed to corresponding inner wall surfaces of the casing 40. As described above, this advantage is manifested especially in a case where one of the scintillator 132 and the board 122, which is lighter than the other, is positioned above the other in the direction indicated by the arrow Z1.

Consequently, if a board 122 made of a light resin material is incorporated in the structure shown in FIG. 11, then the radiation conversion panel 70 preferably is of the reverse side irradiation type, in order to achieve intimate contact between the layers as described above. A reverse side irradiation type of radiation conversion panel 70 is a radiation conversion panel in which the board 122 is positioned near the casing surface that is irradiated with radiation 16, unlike the structure shown in FIG. 5.

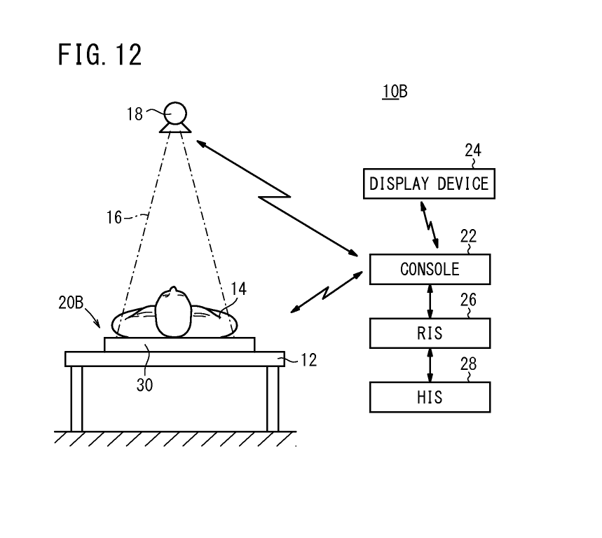

An electronic cassette 20B and a radiographic image capturing system 10B according to a second embodiment of the present invention will be described below with reference to FIGS. 12 through 15.

Parts of the electronic cassette 20B and the radiographic image capturing system 10B, which are identical to those of the electronic cassette 20A and the radiographic image capturing system 10A according to the first embodiment (see FIGS. 1 through 11), are denoted by identical reference characters, and such features will not be described in detail below.

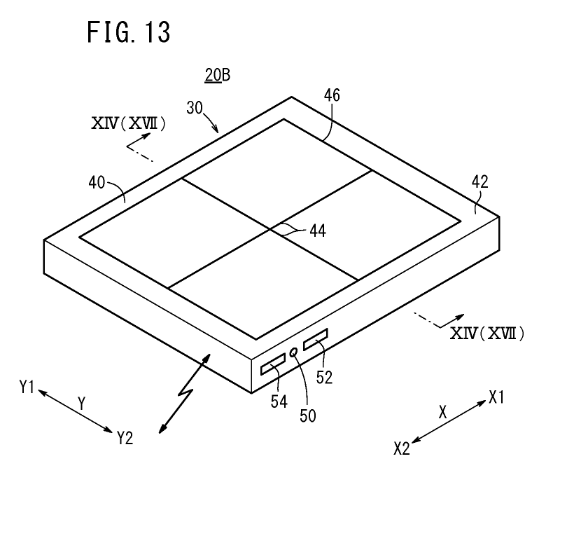

As shown in FIGS. 12 and 13, the electronic cassette 20B and the radiographic image capturing system 10B according to the second embodiment differ from the electronic cassette 20A and the radiographic image capturing system 10A according to the first embodiment in that the panel housing unit 30 is free of a projecting part that functions as a control unit 32.

As shown in FIG. 13, the casing 40 has the AC adapter input terminal 50, the USB terminal 52, and the card slot 54 on a side surface thereof, which faces in the direction of the arrow Y2. The electric arrangement of the electronic cassette 20B is the same as the electric arrangement of the electronic cassette 20A (see FIGS. 3 and 4), and this feature will not be described below.

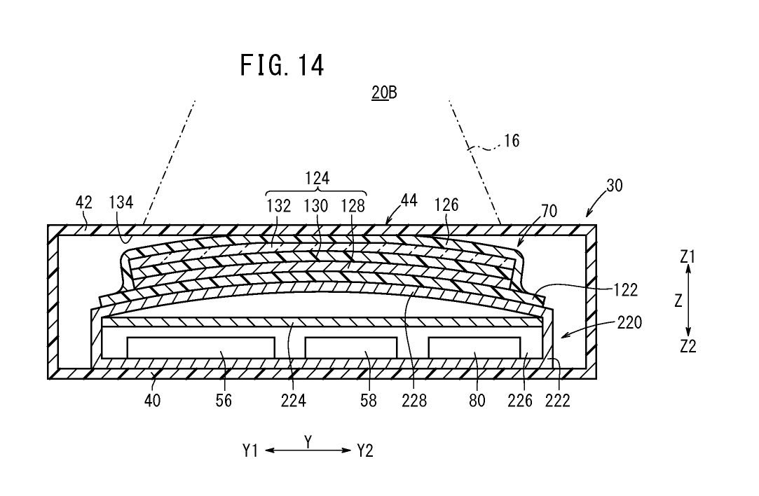

As shown in FIG. 14, the casing 40 houses therein the radiation conversion panel 70 and a base table 220, which supports the radiation conversion panel 70 thereon. The base table 220 has a height in the direction of the arrow Z, which is greater than the height of the base table 120 of the electronic cassette 20A (see FIG. 2). The base table 220 includes a main body 222, which houses therein a shield plate 224 made of a material capable of blocking radiation 16. The base table 220 has a chamber 226 defined therein, which is surrounded by the main body 222 and the shield plate 224. The chamber 226 accommodates therein the power supply 56, the communication unit 58, and the cassette controller 80.

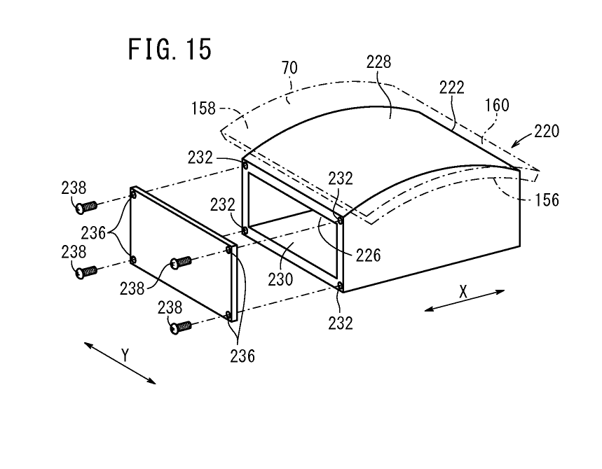

FIG. 15 is an exploded perspective view of the base table 220 shown in FIG. 14. For the sake of brevity, other components associated with the base table 220 are omitted from illustration in FIG. 15. The base table 220 has an upper surface 228, the curvature of which is shown to be greater than the curvature shown in FIG. 14, but the curvature thereof is shown as exaggerated only for facilitating understanding of the present invention, and does not represent the actual size thereof.

The main body 222 of the base table 220 is substantially in the form of a rectangular parallelepiped, whereas the upper surface 228 thereof comprises an upwardly convex curved surface. The base table 220 also has an opening 230 defined in a side wall thereof, which faces in one of the directions indicated by the arrow X. The chamber 226 defined in the main body 222 is large enough to accommodate various units including the power supply 56, etc. The main body 222 has four bolt holes 232 defined in four respective corners of the side wall where the opening 230 is defined. A lid 234 in the form of a rectangular plate has four through holes 236 defined in four respective corners thereof. The lid 234 can be fastened over the opening 230 by four bolts 238, which are threaded through the through holes 236 into the respective bolt holes 232.

The radiation conversion panel 70 is supported on the base table 220, with the reverse surface 156 thereof being held in contact with the upper surface 228. At this time, one end portion 158 and the other end portion 160 of the radiation conversion panel 70 are curved along the curved shape of the upper surface 228 under the weight of the radiation conversion panel 70. The base table 220, which is constructed in this manner, can support the radiation conversion panel 70 in a convex configuration in the placed direction, i.e., in the direction of the arrow Z1, similar to the case of the first embodiment.

The base table 220 may comprise an electromagnetic wave shielding member. For example, aluminum foil may be applied to the base table 220 and may be coated with an electrically conductive coating layer. Alternatively, the entire surface of the base table 220 may be plated with a layer of nickel by an electroless nickel plating process. In this manner, the base table 220 is combined with EMC (Electromagnetic Compatibility) countermeasures, including a noise reduction countermeasure for the circuit board and the electronic components mounted thereon, e.g., the power supply 56, the communication unit 58, and the cassette controller 80 shown in FIG. 14. Thus, the radiation conversion panel 70 and external electronic devices are prevented from operating in error due to noise generated by the circuit board and the electronic components mounted thereon, and the electronic components are prevented from malfunctioning due to noise applied from a source that is external to the electronic cassette 20B.

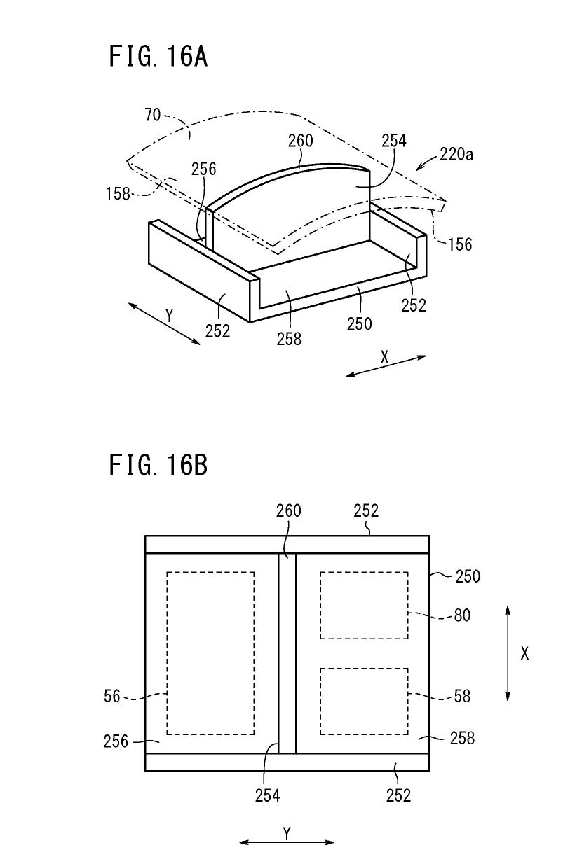

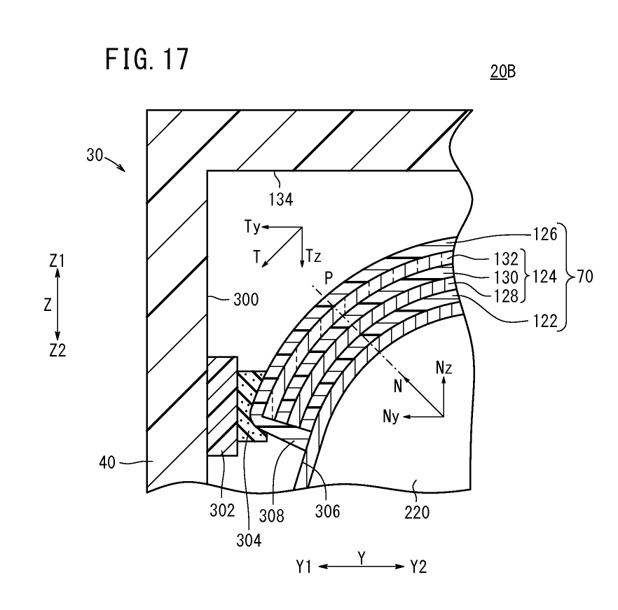

First and second modifications of the electronic cassette 20B according to the second embodiment will be described below with reference to FIGS. 16A through 17.

A first modification of the second embodiment will be described below with reference to FIGS. 16A and 16B. The first modification will be described in detail below with reference to FIGS. 16A and 16B, which show the manner in which the radiation conversion panel 70 is placed on the base table 220, similar to FIG. 15.

A base table 220a comprises a plate-like flat portion 250, two ledges 252 disposed on respective marginal edges on opposite sides of the flat portion 250, which face in the directions indicated by the arrow X, and a main ledge 254 disposed centrally on the flat portion 250 along the direction indicated by the arrow Y. The ledges 252 are each in the form of a rectangular plate that extends in the direction of the arrow Y, and the ledges 252 extend in parallel with each other. The main ledge 254 is erected along a direction normal to the plane of the flat portion 250 and has bell-shaped side surfaces. The main ledge 254 is higher than the two ledges 252. The main ledge 254 has side edges, which are fixed to respective ledges 252 that extend across the side edges. The main ledge 254 divides the upper surface of the flat portion 250 into a first surface 256 and a second surface 258. The main ledge 254 has an upper surface 260, which is formed as a smooth curved surface.

If the base table 220a comprises an electromagnetic wave shielding member, then the electronic components can be disposed on the flat portion 250 of the base table 220a. In FIG. 16B, the power supply 56 is disposed on the first surface 256, whereas the communication unit 58 and the cassette controller 80 are disposed on the second surface 258.

The second modification of the second embodiment will be described below with reference to FIG. 17, which is an enlarged fragmentary cross-sectional view taken along line XVII-XVII of FIG. 13.

The second modification differs from the second embodiment in that the radiation conversion panel 70 is supported not only by the base table 220, but also by the casing 40.

A rectangular fixture 302 is mounted on an inner wall surface of a side wall 300 of the casing 40, which faces in the direction of the arrow Y1. A rectangular protective member 304 is fixed to a side surface of the fixture 302, which faces in the direction of the arrow Y2. The protective member 304 may be made of a soft elastomer, such as silicone rubber or the like, for example.

For housing the radiation conversion panel 70 and the base table 220 in the casing 40, the radiation conversion panel 70 and the base table 220 are placed together in the casing 40. At this time, opposite ends of the radiation conversion panel 70 are fixed to corresponding side walls of the casing 40.

The protective film 126 of the radiation conversion panel 70, which is curved along an outer peripheral surface 306 of the base table 220, is held in abutment against the protective member 304. Thus, the end 308 of the radiation conversion panel 70 is held in a wound state on the outer peripheral surface 306 of the base table 220. Similarly, a fixture and a protective member, not shown, are mounted on an opposite side wall of the casing 40, which faces in the direction of the arrow Y2. Therefore, opposite ends of the radiation conversion panel 70 are fixed to corresponding side walls of the casing 40.

The radiation conversion panel 70, which is fixed in position in this manner, undergoes a resistive force N from the base table 220 at a position P. The resistive force N is generated in a direction normal to the outer peripheral surface 306.

The radiation conversion panel 70 also is displaced depending on the shape of the base table 220, which is positioned underneath the radiation conversion panel 70. Since the end 308 of the radiation conversion panel 70 is fixed in position by the fixture 302 mounted on the casing 40, the radiation conversion panel 70 is subjected to a tensile force T along the direction in which the radiation conversion panel 70 extends.

More specifically, at the position P, the radiation conversion panel 70 undergoes a Z component Nz of the resistive force N in the direction indicated by the arrow Z1, and also undergoes a Z component Tz of the tensile force T in the direction indicated by the arrow Z2. Since the signal output layer 128 and the protective film 126 are pressed by such force components, the photoelectric transducer layer 130 and the scintillator 132, which are disposed inwardly of the signal output layer 128 and the protective film 126, also are pressed. Therefore, the photoelectric transducer layer 130 and the scintillator 132 are held in highly intimate contact with each other.

Inasmuch as opposite ends of the radiation conversion panel 70 are fixed in position through the protective member 304, which is made of a soft elastomer, the opposite ends of the radiation conversion panel 70 are prevented from becoming scratched and damaged.

In addition, marginal edges of the radiation conversion panel 70, i.e., peripheral regions around the point P, and the base table 220 also are held in highly intimate contact with each other. Since the extent of deformation of the radiation conversion panel 70 is stabilized, the shape thereof can be estimated with increased accuracy, so that the image corrector 104 (see FIG. 4) is capable of correcting the captured radiographic image highly accurately.

Finally, an internal arrangement of the radiation conversion panel 70 will be described below.

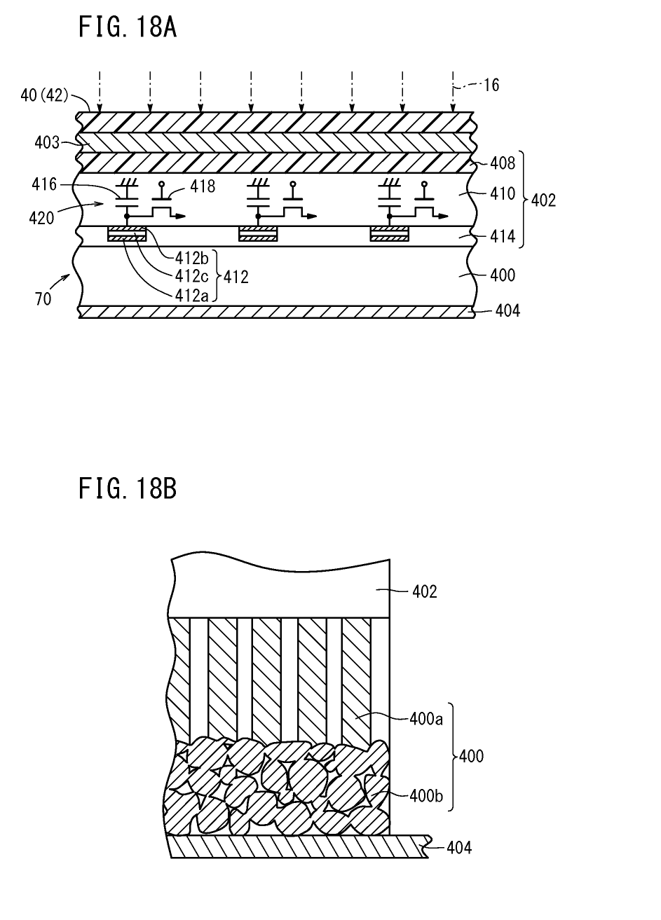

As shown in FIGS. 18A and 18B, the radiation conversion panel 70 includes a scintillator 400 for converting radiation 16 that has passed through the subject 14 into visible light, i.e., absorbing radiation 16 and emitting visible light, and a radiation detector 402 for converting visible light from the scintillator 400 into electric signals, i.e., electric charges, representative of a radiographic image. A grid 403 for removing scattered rays of radiation 16 is interposed between the casing 40, i.e., the image capturing surface 42, and the radiation detector 402.

Radiation conversion panels 70 include a face side reading type, i.e., an ISS (Irradiation Side Sampling) type, of radiation conversion panel, in which the radiation detector 402 and the scintillator 400 are disposed successively from the image capturing surface 42 that is irradiated with radiation 16, and a reverse side reading type, i.e., a PSS (Penetration Side Sampling) type, of radiation conversion panel, in which the scintillator 400 and the radiation detector 402 are disposed successively from the image capturing surface 42.

The scintillator 400 emits stronger light from the side that is closer to the image capturing surface 42 irradiated with radiation 16. Since the scintillator 400 is positioned closer to the image capturing surface 42 in an ISS type than in a PSS type, an ISS type of radiation conversion panel 70 produces a radiographic image of higher resolution, and the radiation detector 402 thereof detects a greater amount of visible light from the scintillator 400. Accordingly, an ISS type of radiation conversion panel 70 (electronic cassette 20A, 20B) is more sensitive than a PSS type of radiation conversion panel 70.

The scintillator 400 may be made of a material such as CsI:TI (thallium-added cesium iodide), CsI:Na (sodium-activated cesium iodine), GOS(Gd₂O₂S:Tb), or the like.

FIG. 18B shows the scintillator 400 including a columnar crystal region, which is produced by evaporating a material containing CsI on an evaporation board 404.

More specifically, the scintillator 400 shown in FIG. 18B includes a columnar crystal region, which is made up of columnar crystals 400a close to the image capturing surface 42, i.e., the radiation detector 402 that is irradiated with radiation 16, and a non-columnar crystal region, which is made up of non-columnar crystals 400b remote from the image capturing surface 42. The evaporation board 404 preferably is made of a highly heat-resistant material, e.g., aluminum (Al), in light of its low cost. The columnar crystals 400a in the scintillator 400 have a substantially uniform average diameter along the longitudinal direction of the columnar crystals 400a.

As described above, the scintillator 400 includes the columnar crystal region, i.e., the columnar crystals 400a, and the non-columnar crystal region, i.e., the non-columnar crystals 400b. The columnar crystal region of the columnar crystals 400a, which are capable of highly efficient light emission, is disposed close to the radiation detector 402. Therefore, visible light emitted by the scintillator 400 travels through the columnar crystals 400a to the radiation detector 402. As a result, visible light emitted toward the radiation detector 402 is prevented from spreading, so that a radiographic image detected by the electronic cassettes 20A, 20B is prevented from blurring. Since visible light that has reached a deep region of the scintillator 400, i.e., the non-columnar crystal region, is reflected toward the radiation detector 402 by the non-columnar crystals 400b, the amount of visible light that is applied to the radiation detector 402, i.e., the efficiency at which visible light emitted by the scintillator 400 is detected, is increased.

Assuming that the columnar crystal region of the scintillator 400, which is positioned close to the image capturing surface 42, has a thickness t1, whereas the non-columnar crystal region of the scintillator 400, which is positioned close to the evaporation board 404, has a thickness t2, then the thicknesses t1, t2 preferably satisfy the relationship 0.01≦(t2/t1)≦0.25.

If the thickness t1 of the columnar crystal region and the thickness t2 of the non-columnar crystal region satisfy the above relationship, the ratio of the region of high light emission efficiency that prevents visible light from spreading, i.e., the columnar crystal region, and the region that reflects visible light, i.e., the non-columnar crystal region, along the thicknesswise direction of the scintillator 400 falls within an appropriate range, thereby increasing the light emission efficiency of the scintillator 400, the efficiency at which visible light emitted by the scintillator 400 is detected, and the resolution of the detected radiographic image.

If the thickness t2 of the non-columnar crystal region is too large, then a region of low light emission efficiency increases, resulting in a reduction in sensitivity of the electronic cassettes 20A, 20B. The ratio (t2/t1) preferably is in a range from 0.02 to 0.1.

The scintillator 400 described above includes the columnar crystal region and the non-columnar crystal region, which are arranged in succession. The non-columnar crystal region may be replaced with a light reflecting layer made of Al or the like, such that only the columnar crystal region is included. The scintillator 400 may alternatively be of another structure.

The radiation detector 402 detects visible light emitted from a light emission side, i.e., the columnar crystals 400a, of the scintillator 400. In side elevation, as shown in FIG. 18A, the radiation detector 402 includes an insulative substrate 408, a TFT layer 410, and a plurality of photoelectric transducers 412 successively deposited on the image capturing surface 42 along the direction in which radiation 16 is applied. A planarization layer 414 is disposed on the bottom surface of the TFT layer 410 in covering relation to the photoelectric transducers 412.

The radiation detector 402 is constructed as a TFT active matrix board (hereinafter referred to as a “TFT board”) comprising a matrix of pixels 420 disposed on the insulative substrate 408 as viewed in plan. Each of the pixels 420 has a photoelectric transducer 412 such as a photodiode (PD) or the like, a storage capacitor 416, and a TFT 418.

The TFTs 418 correspond to the TFTs 82 (see FIG. 4) described above in the first embodiment, and the photoelectric transducers 412 and the storage capacitors 416 correspond to the pixels 72.

The photoelectric transducer 412 comprises a lower electrode 412a close to the scintillator 400, an upper electrode 412b close to the TFT layer 410, and a photoelectric conversion film 412c disposed between the lower electrode 412a and the upper electrode 412b. The photoelectric conversion film 412c absorbs visible light emitted from the scintillator 400 and generates electric charges depending on the absorbed visible light.

Since the lower electrode 412a is required to allow visible light emitted from the scintillator 400 to be applied to the photoelectric conversion film 412c, the lower electrode 412a preferably is made of an electrically conductive material, which is transparent at least to the wavelength of visible light emitted from the scintillator 400. More specifically, the lower electrode 412a preferably is made of a transparent conducting oxide (TCO) having a high transmittance to visible light and low resistance.

The lower electrode 412a may be in the form of a thin metal film made of Au or the like. However, TCO is preferable because such a thin metal film tends to have increased resistance if the thin metal film has a light transmittance of 90% or higher. For example, the lower electrode 412a preferably is made of ITO (Indium Tin Oxide), IZO (Indium Zinc Oxide), AZO (Aluminum-doped Zinc Oxide), FTO (Fluorine-doped Tin Oxide), SnO₂, TiO₂, ZnO₂, or the like. Among these oxides, ITO is most preferable in view of processing simplicity, low resistance, and transparency. The lower electrode 412a may be in the form of either a single electrode shared by all of the pixels 420 or a plurality of divided electrodes assigned to the respective pixels 420.

The photoelectric conversion film 412c may be made of a material that absorbs visible light and generates electric charges from the absorbed visible light. For example, the photoelectric conversion film 412c may be made of amorphous silicon (a-Si), an organic photoconductor (OPC) material, or the like. If the photoelectric conversion film 412c is made of amorphous silicon, then the photoelectric conversion film 412c can absorb visible light emitted from the scintillator 400 in a wide range of wavelengths. However, since an evaporation process needs to be carried out to make the photoelectric conversion film 412c of amorphous silicon, heat resistance of the insulative substrate 408 has to be taken into account if the insulative substrate 408 is made of synthetic resin.

If the photoelectric conversion film 412c is made of a material containing an organic photoconductor material, then since the photoelectric conversion film 412c has an absorption spectrum exhibiting high absorption in the visible light range, the photoelectric conversion film 412c absorbs almost no electromagnetic waves apart from the visible light emitted from the scintillator 400. As a result, the photoelectric conversion film 412c generates almost no noise upon absorption of radiation 16, which may be X-rays, γ-rays, or the like.

The photoelectric conversion film 412c, which is made of an organic photoconductor material, can be fabricated by depositing the organic photoconductor material onto a target from a liquid droplet propulsion head such as an ink jet head or the like. Therefore, the target is not required to be resistant to heat. According to the present structural example, the photoelectric conversion film 412c is made of an organic photoconductor material.

If the photoelectric conversion film 412c is made of an organic photoconductor material, then since the photoelectric conversion film 412c absorbs almost no radiation 16, attenuation of radiation 16 that passes through the radiation detector 402 is minimized in an ISS type of radiation conversion panel 70, in which the radiation detector 402 is positioned so as to have radiation 16 pass therethrough. Therefore, the sensitivity of the radiation conversion panel 70 with respect to radiation 16 is prevented from becoming reduced. A photoelectric conversion film 412c made of an organic photoconductor material is particularly preferable in an ISS type of radiation conversion panel 70.

The organic photoconductor material of the photoelectric conversion film 412c preferably has an absorption peak wavelength, which is as close to the peak wavelength of the visible light emitted from the scintillator 400 as possible, in order to absorb visible light emitted from the scintillator 400 most efficiently. Although the absorption peak wavelength of the organic photoconductor material and the peak wavelength of visible light emitted from the scintillator 400 ideally are equal to each other, if the difference between the peak wavelengths is small enough, then the organic photoconductor material sufficiently absorbs visible light emitted from the scintillator 400. More specifically, the difference between the absorption peak wavelength of the organic photoconductor material and the peak wavelength of the visible light emitted from the scintillator 400 preferably is 10 nm or smaller, or more preferably, is 5 nm or smaller.

Organic photoconductor materials that meet the above requirements include quinacridone-based organic compounds and phthalocyanine-based organic compounds, for example. Since quinacridone has an absorption peak wavelength of 560 nm in the visible range, if quinacridone is used as the organic photoconductor material and CsI:Tl is used as the material of the scintillator 400, then the difference between the above peak wavelengths can be reduced to 5 nm or smaller, making it possible to substantially maximize the amount of electric charge generated by the photoelectric conversion film 412c.

The photoelectric conversion film 412c, which is applied to the radiation conversion panel 70, will be described in specific detail below.

The radiation conversion panel 70 includes an electromagnetic wave absorption/photoelectric conversion region provided by an organic layer, including the upper and lower electrodes 412b, 412a, and the photoelectric conversion film 412c sandwiched between the upper and lower electrodes 412b, 412a. The organic layer may be formed by a superposition or mixture of an electromagnetic wave absorption region, a photoelectric conversion region, an electron transport region, a hole transport region, an electron blocking region, a hole blocking region, a crystallization preventing region, an electrode, and an interlayer contact improving region, etc.

The organic layer preferably includes an organic p-type compound or an organic n-type compound. An organic p-type semiconductor (compound) is a donor organic semiconductor (compound) mainly typified by a hole transport organic compound, and refers to an organic compound that tends to donate electrons. More specifically, when two organic materials are used in contact with each other, one of the organic materials, which has a lower ionization potential, is referred to as a donor organic compound. Any type of organic compound capable of donating electrons can be used as a donor organic compound. An organic n-type semiconductor (compound) is an acceptor organic semiconductor (compound) mainly typified by an electron transport organic compound, and refers to an organic compound that tends to accept electrons. More specifically, when two organic materials are used in contact with each other, one of the organic materials, which has a larger electron affinity, is referred to as an acceptor organic compound. Any type of organic compound capable of accepting electrons can be used as an acceptor organic compound.

Materials that can be used as the organic p-type semiconductor and the organic n-type semiconductor, and arrangements of the photoelectric conversion film 412c, are disclosed in detail in Japanese Laid-Open Patent Publication No. 2009-032854, and will not be described in detail below.

Each of the photoelectric transducers 412 may include at least the upper electrode 412b, the lower electrode 412a, and the photoelectric conversion film 412c. For preventing dark current from increasing, each of the photoelectric transducers 412 preferably additionally includes either an electron blocking film or a hole blocking film, and more preferably, includes both the electron blocking film and the hole blocking film.

The electron blocking film may be disposed between the upper electrode 412b and the photoelectric conversion film 412c. When a bias voltage is applied between the upper electrode 412b and the lower electrode 412a, the electron blocking film can prevent electrons from being injected from the upper electrode 412b into the photoelectric conversion film 412c, thereby preventing dark current from increasing. The electron blocking film may be made of an organic material capable of donating electrons. The electron blocking film is actually made of a material that is selected depending on the material of the adjacent electrode and the material of the adjacent photoelectric conversion film 412c. A preferable material should have an electron affinity (Ea) that is at least 1.3 eV greater than the work function (Wf) of the material of the adjacent electrode and an ionization potential (Ip) equal to or smaller than the Ip of the material of the adjacent photoelectric conversion film 412c. Materials that can be used as an organic material which can donate electrons are disclosed in detail in Japanese Laid-Open Patent Publication No. 2009-032854, and will not be described in detail below.

The thickness of the electron blocking film preferably is in the range from 10 nm to 200 nm, more preferably, is in the range from 30 nm to 150 nm, or particularly preferably, is in the range from 50 nm to 100 nm, in order to reliably achieve a dark current reducing capability and to prevent the photoelectric conversion efficiency of the photoelectric transducer 412 from being lowered.

The hole blocking film may be disposed between the photoelectric conversion film 412c and the lower electrode 412a. If a bias voltage is applied between the upper electrode 412b and the lower electrode 412a, the hole blocking film can prevent holes from being injected from the lower electrode 412a into the photoelectric conversion film 412c, thereby preventing dark current from increasing. The hole blocking film may be made of an organic material capable of accepting electrons. The hole blocking film is actually made of a material that is selected depending on the material of the adjacent electrode and the material of the adjacent photoelectric conversion film 412c. A preferable material should have an ionization potential (Ip) that is at least 1.3 eV greater than the work function (Wf) of the material of the adjacent electrode and an electron affinity (Ea) equal to or greater than the Ea of the material of the adjacent photoelectric conversion film 412c. Materials that can be used as an organic material that can accept electrons are disclosed in detail in Japanese Laid-Open Patent Publication No. 2009-032854, and will not be described in detail below.

The thickness of the hole blocking film preferably is in the range from 10 nm to 200 nm, more preferably, is in the range from 30 nm to 150 nm, and particularly preferably, is in the range from 50 nm to 100 nm, in order to reliably achieve a dark current reducing capability and to prevent the photoelectric conversion efficiency of the photoelectric transducer 412 from being lowered.

For setting a bias voltage to move holes, from among the electric charges generated in the photoelectric conversion film 412c, toward the lower electrode 412a, and to move electrons, from among the electric charges generated in the photoelectric conversion film 412c, toward the upper electrode 412b, the electron blocking film and the hole blocking layer may be switched in position. Both the electron blocking film and the hole blocking layer are not required, but either one of the electron blocking film or the hole blocking layer may be included in order to provide a certain dark current reducing capability.

Each of the TFTs 418 in the TFT layer 410 includes a stacked assembly made up of a gate electrode, a gate insulating film, and an active layer (channel layer). A source electrode and a drain electrode are disposed on the active layer and are spaced from each other with a gap therebetween. The active layer may be made of any one of amorphous silicon, an amorphous oxide, an organic semiconductor material, carbon nanotubes, etc., but is not limited thereto.

The amorphous oxide, which the active layer may be made of, preferably is an oxide (e.g., In—O oxide) including at least one of In, Ga, and Zn, more preferably, is an oxide (e.g., In—Zn—O oxide, In—Ga oxide, or Ga—Zn—O oxide) including at least two of In, Ga, and Zn, and particularly preferably, is an oxide including In, Ga, and Zn. An In—Ga—An—O amorphous oxide preferably is an amorphous oxide the crystalline composition of which is represented by InGaO₃ (ZnO)ₘ where m represents a natural number smaller than 6, and particularly preferably, is InGaZnO₄. However, the amorphous oxide, which the active layer may be made of, is not limited to such oxides.

The organic semiconductor material, which the active layer may be made of, may be a phthalocyanine compound, pentacene, vanadyl phthalocyanine, or the like, but is not limited to such materials. The composition of a phthalocyanine compound is disclosed in detail in Japanese Laid-Open Patent Publication No. 2009-212389, and will not be described in detail below.

If the active layer of the TFTs 418 is made of any one of an amorphous oxide, an organic semiconductor material, and carbon nanotubes, then since the active layer does not absorb radiation 16 such as X-rays or the like, or absorbs an extremely small amount of radiation 16, the active layer is effective at reducing noise generated in the radiation detector 402.

If the active layer is made of carbon nanotubes, then the TFTs 418 have a high switching speed and can exhibit a low absorption rate for light in the visible range. If the active layer is made of carbon nanotubes, then since the performance of the TFTs 418 could be significantly degraded by trace metal impurities mixed therewith, it is necessary to separate and extract highly pure carbon nanotubes by a centrifugal separator or the like, and to use separated and extracted highly pure carbon nanotubes to make the active layer.

Since a film made of an organic photoconductor material and a film made of an organic semiconductor material are sufficiently flexible, a combination of the photoelectric conversion film 412c, which is made of an organic photoconductor material, and the TFTs 418, the active layer of which is made of an organic semiconductor material, makes it unnecessary for the radiation detector 402 to be highly rigid, although the weight of the subject 14 is applied as a load to the radiation detector 402.

The insulative substrate 408 may be made of a material, which is permeable to light and absorbs only a small amount of radiation 16. The amorphous oxide of the active layer of the TFTs 418 and the organic photoconductor material of the photoelectric conversion film 412c of the photoelectric transducers 412 can be deposited as films at low temperatures. Therefore, the insulative substrate 408 is not limited to a highly heat-resistant substrate such as a semiconductor substrate, a quartz substrate, a glass substrate, or the like, but may be a flexible plastic substrate, a substrate made of aramid fibers, or a substrate made of bionanofibers. More specifically, the insulative substrate 408 may be a flexible substrate of polyester such as polyethylene terephthalate, polybutylene phthalate, polyethylene naphthalate, or the like, or polystyrene, polycarbonate, polyethersulfone, polyarylate, polyimide, polycycloolefin, norbornene resin, poly(chlorotrifluoro-ethylene), or the like. Such a flexible plastic substrate makes the radiation detector 402 light in weight and hence easy to carry around. The insulative substrate 408 may include an insulating layer that makes the insulative substrate 408 electrically insulative, a gas barrier layer that makes the insulative substrate 408 impermeable to water and oxygen, and an undercoat layer that makes the insulative substrate 408 flat for enhancing intimate contact with the electrode.

Aramid fibers for use as the insulative substrate 408 are advantageous in that, since a high-temperature process at 200 degrees Celsius or higher can be applied thereto, aramid fibers allow a transparent electrode material to be set at a high temperature for achieving lower resistance, and also allow driver ICs to be automatically mounted thereon by a process including a solder reflow process. Furthermore, inasmuch as aramid fibers have a coefficient of thermal expansion close to ITO and glass, an insulative substrate made of aramid fibers is less likely to warp or crack after fabrication. In addition, an insulative substrate made of aramid fibers may be made thinner than a glass substrate or the like. The insulative substrate 408 may be in the form of a stacked assembly of an ultrathin glass substrate and aramid fibers.

Bionanofibers are made by compounding a bundle of cellulose microfibrils (bacteria cellulose) produced by bacteria (acetic acid bacteria, Acetobacter Xylinum) and a transparent resin. The bundle of cellulose microfibrils has a width of 50 nm, which is 1/10 of the wavelength of visible light, is highly strong and highly resilient, and is subject to low thermal expansion. Bionanofibers that contain 60% to 70% of fibers and exhibit a light transmittance of about 90% at a wavelength of 500 nm can be produced by impregnating bacteria cellulose with a transparent resin such as an acrylic resin, an epoxy resin, or the like, and then allowing the transparent resin to set. Bionanofibers are flexible and have a low coefficient of thermal expansion ranging from 3 ppm to 7 ppm, which is comparable to silicon crystals, a high strength of 460 Mpa that matches the strength of steel, and a high resiliency of 30 GPa. Therefore, an insulative substrate 408 made of bionanofibers can be thinner than glass substrates or the like.

If the insulative substrate 408 comprises a glass substrate, then the overall thickness of the radiation detector 402, i.e., a TFT board, is about 0.7 mm, for example. According to the present arrangement, the insulative substrate 408 comprises a thin substrate of synthetic resin, which is permeable to light and is used to make the electronic cassettes 20A, 20B. Thus, the overall thickness of the radiation detector 402 is reduced to about 0.1 mm, for example, thereby making the radiation detector 402 flexible. Consequently, the electronic cassettes 20A, 20B are more resistant to shocks and hence are less susceptible to damage if shocked. Plastics, aramid fibers, and bionanofibers absorb a small amount of radiation 16. If the insulative substrate 408 is made of any of these materials, then since the amount of radiation 16 absorbed by the insulative substrate 408 is small, the sensitivity of the radiation detector 402 with respect to radiation 16 is prevented from becoming reduced, even though radiation 16 passes through an ISS type of radiation detector 402.

The insulative substrate 408 of the electronic cassettes 20A, 20B need not necessarily be made of a synthetic resin, but may be made of another material such as glass, although a glass substrate tends to make the electronic cassettes 20A, 20B thicker.

The planarization layer 414 for planarizing the radiation detector 402 is disposed on the side of the radiation detector 402, i.e., the TFT board, which is close to the scintillator 400, i.e., remote from the side of the radiation detector 402 to which radiation 16 is applied.

According to the present arrangement, the radiation conversion panel 70 may be arranged in the following ways.

(1) The photoelectric transducers 412, which comprise PDs, may be made of an organic photoconductor material, and the TFT layer 410 may be constructed to incorporate CMOS sensors therein. Since only the PDs are made of an organic photoconductor material, the TFT layer 410 including the CMOS sensors may not be flexible. The photoelectric transducers 412, which are made of an organic photoconductor material, and the CMOS sensors are disclosed in detail in Japanese Laid-Open Patent Publication No. 2009-212377, and such features will not be described in detail below.

(2) The photoelectric transducers 412, which comprise photodiodes, may be made of an organic photoconductor material, and the TFT layer 410 may be made flexible by incorporating CMOS circuits having TFTs made of an organic material. The CMOS circuits employ a p-type organic semiconductor material made of pentacene, and an n-type organic semiconductor material made of fluorinated copper phthalocyanine (F₁₆CuPc). Thus, the TFT layer 410 is made flexible and is capable of being bent to a smaller radius of curvature. Thus, the TFT layer 410 is effective at significantly reducing the gate insulating film for enabling a lower drive voltage. Furthermore, the gate insulating film, the semiconductor, and the electrodes can be fabricated at room temperature, or at temperatures that are equal to or lower than 100° C. The CMOS circuits may be fabricated directly on the flexible insulative substrate 408. The TFTs, which are made of an organic material, may be microfabricated by a fabrication process that is subject to a scaling law. The insulative substrate 408 may be produced as a flat substrate free of surface irregularities by coating a thin polyimide substrate with a polyimide precursor, and then heating the applied polyimide precursor into polyimide.

(3) PDs and TFTs that are made of crystalline Si may be fabricated on the insulative substrate 408, which is a resin substrate, by a fluidic self-assembly process. The fluidic self-assembly process allows a plurality of device blocks on the order of microns to be placed at designated positions on a substrate. More specifically, the PDs and the TFTs, which constitute device blocks on the order of microns, are prefabricated on another substrate and then separated from the substrate. Then, the PDs and the TFTs are dipped in liquid and spread onto the insulative substrate 408 as a target substrate, so that the PDs and the TFTs are statistically placed at respective positions. The insulative substrate 408 is processed in advance to adapt itself to the device blocks, so that the device blocks can selectively be placed on the insulative substrate 408. Accordingly, the device blocks, i.e., the PDs and the TFTs, which are made of an optimum material, can be integrated on the insulative substrate 408 as an optimum substrate. It is thus possible to integrate the PDs and the TFTs on the insulative substrate 408 as a non-crystalline resin substrate.

The present invention is not limited to the above embodiments, but various arrangements may be adopted therein without departing from the scope of the invention.

For example, the console 22 may acquire ID information of the electronic cassettes 20A, 20B, and may further acquire corrective data for each radiation conversion panel 70 that is associated with the ID information, for thereby allowing an image processor in the console 22 to correct the radiographic image.

The photoelectric transducer layer 130 and the scintillator 132 may be stacked in a sequence, which is a reversal of the sequence according to the above embodiments. More specifically, the scintillator 132 and the photoelectric transducer layer 130 may be stacked in this order on the signal output layer 128.

What is claimed is:

1. A radiographic image capturing apparatus comprising a radiation conversion panel for converting radiation into a radiographic image, the radiation conversion panel comprising a stacked assembly made up of a scintillator and a photoelectric transducer layer, a base table supporting the radiation conversion panel which is placed on the base table, and a casing housing the radiation conversion panel and the base table in the casing,
wherein the base table supports the radiation conversion panel while deforming the radiation conversion panel into a convex shape along a direction in which the radiation conversion panel is placed on the base table.

2. The radiographic image capturing apparatus according to claim 1, wherein the base table supports the radiation conversion panel while curving the radiation conversion panel.

3. The radiographic image capturing apparatus according to claim 1, wherein the base table supports the radiation conversion panel while deforming the radiation conversion panel axisymmetrically with respect to a prescribed axis on a detecting surface of the radiation conversion panel.

4. The radiographic image capturing apparatus according to claim 3, wherein the prescribed axis comprises a central line of the detecting surface.

5. The radiographic image capturing apparatus according to claim 1, wherein the radiation conversion panel has at least a pair of side surfaces fixed to inner wall surfaces of the casing.

6. The radiographic image capturing apparatus according to claim 1, wherein the base table is made of a resin material.

7. The radiographic image capturing apparatus according to claim 1, wherein the base table is made of an electromagnetic wave shielding material.

8. The radiographic image capturing apparatus according to claim 1, further comprising an image corrector for correcting the radiographic image depending on an extent of deformation of the radiation conversion panel.

9. The radiographic image capturing apparatus according to claim 8, wherein the image corrector estimates the extent of deformation of the radiation conversion panel based on a shape of the base table and corrects the radiographic image.
